(19) United States
(12) Patent Application Publication
(10) Pub. No.: US 2022/0343187 A1
(43) Pub. Date: Oct. 27, 2022

(54) SYSTEM AND METHOD FOR ESTIMATING METRIC FORECASTS ASSOCIATED WITH RELATED ENTITIES WITH MORE ACCURACY BY USING A METRIC FORECAST ENTITY RELATIONSHIP MACHINE LEARNING MODEL

(71) Applicant: SAMYA.AI TECHNOLOGIES PRIVATE LIMITED, Bangalore (IN)

(72) Inventors: Deepinder Singh DHINGRA, Bangalore (IN); Yadunath Gupta, Rewa (IN); Siddharth Shahi, Lucknow (IN); Ankur Verma, Bangalore (IN)

(21) Appl. No.: 17/837,004

(22) Filed: Jun. 9, 2022

Related U.S. Application Data
(63) Continuation of application No. PCT/IB2022/053780, filed on Apr. 22, 2022.

(30) Foreign Application Priority Data
Apr. 23, 2021 (IN) 202141018868

(51) Int. Cl. G06N 5/02; G06Q 10/04

(52) U.S. Cl. CPC G06N 5/022; G06Q 10/04

(57) ABSTRACT

A method for estimating metric forecasts associated with a plurality of related entities with more accuracy by training and applying a metric forecast entity relationship machine learning (ML) model is provided. The method includes obtaining a first primary and a first secondary entity metric forecast based on historical data of a primary entity metric obtained from primary entity metric device and historical data of secondary entity metric obtained from secondary entity metric device at different instances of time, training metric forecast entity relationship ML model based on relationship between first primary and first secondary entity metric forecast to obtain a trained metric entity relationship ML model that accounts for the relationship between the first primary entity metric forecast and the first secondary entity metric forecast, and estimating a second primary entity metric forecast and a second secondary entity metric forecast based on the trained metric entity relationship ML model.

### RELATED APPLICATIONS

This application is a Continuation Application of PCT/IB2022/053780, filed Apr. 22, 2022, which claims priority benefit of Indian Patent Application No. 202141018868, filed Apr. 23, 2021, which are incorporated entirely by reference herein for all purposes.

### FIELD

The present disclosure relates generally to metric forecast; and more specifically to a system and method for estimating metric forecasts associated with related entities with more accuracy by using a metric forecast entity relationship machine learning model.

### BACKGROUND

Metric forecasts are often generated in an organization based on corresponding specific business functions and according to specific requirements of business units (also known as “entities”) comprised in the organization. For example, an organization dealing with consumer goods may need to generate metric forecasts for the demand and supply chain planning requirements of entities such as marketing, production, inventory and the like.

Metric forecasts are generated in an organization based on the specific objectives that an organization desires to meet. As such, metric forecasts generated for the entities are based on the specific objectives that the entity desires to meet. For example, in an organization producing consumer goods, metric forecasts may be generated for the demand and supply chain needs for various distribution channels, viz., the organization, the distributors and the retailers. The demand and supply chain needs of the retailers, in general, impacts the supply chain needs of the distributors and further that of the organization. Accordingly, such entities (retailer, distributor) are considered as related entities and accordingly the metric forecasts are often generated for such related entities.

The metric forecasts generated for such related entities are impacted by the operating parameters (constraints) specified for the organization as well. For example, the metric forecasts to generate for the distributors and for the retailers are impacted due to policies specified for the order, sales and distribution, inventory management, pricing and the like in the organization. The metric forecasts generated for such entities are in addition impacted by the systems and processes that enable operations of different entities focused towards optimizing corresponding factor groups. For example, in the organization, the entity associated with a promotions factor group may optimize for factors such as average price of an item or a cost of a promotion activity, whereas the entity associated with an inventory placement and allocation factor group may optimize for corresponding factor group which includes factors such as demand consumption, network path, order frequency and the like. The factor group may include a pricing and promotions factor group, a sales and distribution factor group, or an inventory placement and allocation factor group. The pricing and promotions factor group includes at least one of a location, a store, a product, a price-pack, a placement of product, a placement, a range, a visibility, a coverage, a frequency, a distribution reach, a channel, an event type or an inventive. The sales and distribution factor group includes at least one of a channel, a location of a promotion activity, a product for promotion, a price-pack, a time period or a calendar for a promotion activity, a promotion type, a price for a promotion activity, a discount for a promotion activity, or a creative for a promotion activity. The inventory placement and allocation factor group includes at least one of a location of inventory, a store of inventory, a type of inventory, a source location of inventory, a transfer of inventory, a new quantity for the inventory, a safety stock of inventory for a product, on hand levels of inventory or a reorder quantity of inventory, or an allocation quantity of inventory.

Inaccuracies in metric forecasts in an organization impacts the business in one or more manner. For example, any inaccuracies in the demand planning impacts the economic aspects for the organization. As is well known, machine learning models for metrics forecasting result in greater accuracy. However, in the case of related entities, it is desirable that the machine learning model is trained to identify relationships between the entity metric forecasts generated for the corresponding entities such that the metric forecasts estimated for the related entities are with greater accuracy.

Existing systems or devices for generation of metric forecasts are based on machine learning models that employ algorithms to merely identify any dependency the output variable may have with one or more input variables comprising a corresponding metric forecast, for optimizing selection of output objectives for generation of corresponding metric forecast etc.

Therefore, in light of the foregoing discussion, there exists a need to estimating metric forecasts associated with related entities with more accuracy by using a metric forecast entity relationship machine learning model.

### SUMMARY

It is an object of the present disclosure to provide a system and method for estimating metric forecasts associated with related entities with more accuracy by using a metric forecast entity relationship machine learning model.

This object is achieved by the features of the independent claims. Further implementation forms are apparent from the dependent claims, the description, and the figures.

According to a first aspect of the disclosure, there is provided a method for estimating metric forecasts associated with a plurality of related entities with more accuracy by training and applying a metric forecast entity relationship machine learning model. The method includes obtaining a first primary entity metric forecast and a first secondary entity metric forecast based on historical data of a primary entity metric obtained from a primary entity metric device and historical data of a secondary entity metric obtained from a secondary entity metric device at different instances of time. The method includes training a metric forecast entity relationship machine learning model based on a relationship between the first primary entity metric forecast and the first secondary entity metric forecast to obtain a trained metric entity relationship machine learning model that accounts for the relationship between the first primary entity metric forecast and the first secondary entity metric forecast. The method includes estimating a second primary entity metric forecast and a second secondary entity metric forecast based on the trained metric entity relationship machine learning model.

The method is of advantage in that the method improves the accuracy in estimating related entity metric forecast as the estimation is based on the metric entity relationship machine learning model. The entity relationship machine learning model is trained based on high performance algorithms to process historical data values to account for the underlying relationship between the entity metric forecast. The method is further of advantage due to the improved learning capability over time resulting in continuous improvement in accuracy in estimating metric forecasts associated with related entities.

According to a second aspect, there is provided a system for estimating metric forecasts associated with a plurality of related entities with more accuracy by training and applying a metric forecast entity relationship machine learning model is provided. The system comprises one or more historical data storages, a data communication network, a primary entity metric device, a secondary entity metric device, a tertiary entity metric device, a server, a data storage, wherein the server system is operable to perform the steps of (a) obtaining a first primary entity metric forecast and a first secondary entity metric forecast based on historical data of a primary entity metric obtained from a primary entity metric device and historical data of a secondary entity metric obtained from a secondary entity metric device at different instances of time, (b) training a metric forecast entity relationship machine learning model based on a relationship between the first primary entity metric forecast and the first secondary entity metric forecast to obtain a trained metric entity relationship machine learning model that accounts for the relationship between the first primary entity metric forecast and the first secondary entity metric forecast, and, (c) estimating a second primary entity metric forecast and a second secondary entity metric forecast based on the trained metric entity relationship machine learning model.

The system is of advantage in that the system provides an improved processing speed while estimating related metric forecast by training a metric entity relationship machine learning model. The system estimating the metric entity relationship machine learning model (built using programming languages such as R, python, pyspark, etc.) is enabled to benefit from the hardware architecture including an optimized memory utilization for processing and thereby result in higher processing speed. In addition, the system due to the use of the metric entity relationship machine learning model for estimating metric forecasts improves the accuracy in estimating metric forecasts for similar reasons as described above with respect to the method noted above.

A technical problem in the prior art is resolved, where the technical problem is with computing accuracy in estimation of metric forecasts associated with related entities and also the number of devices involved in performing the estimation.

Therefore, in contradistinction to the prior art, according to the method for estimating metric forecasts associated with related entities and the system for estimating metric forecasts associated with related entities accuracy of estimation is improved by using a metric forecast entity relationship machine learning model. Further, the disclosure allows reduction in processing time due to use of a trained metric forecast entity relationship machine learning model for the estimation.

These and other aspects of the disclosure will be apparent from and the implementation(s) described below.

### BRIEF DESCRIPTION OF THE DRAWINGS

Implementations of the disclosure will now be described, by way of example only, with reference to the accompanying drawings, in which:

FIG. 1 is being a block diagram that illustrates an environment in which a server system is operable to estimate metric forecasts associated with related entities with more accuracy by using a metric forecast entity relationship machine learning model in accordance with an embodiment of the disclosure;

FIG. 2 is a flow diagram that illustrates steps of a method performed by server system for estimating metric forecasts associated with related entities with more accuracy by using a metric forecast entity relationship machine learning model in accordance with an implementation of the disclosure;

FIG. 3 is a block diagram that illustrates elements of the server (150) in accordance with an implementation of the disclosure;

FIG. 4 is an interaction diagram that illustrates a method of estimating metric forecasts associated with related entities with more accuracy by using a metric forecast entity relationship machine learning model in accordance in accordance with an example implementation of the disclosure; and

FIG. 5 is an illustration of a computing arrangement for use in implementing implementations of the disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF PREFERRED EMBODIMENTS

Implementations of the disclosure provide a method and system for estimating metric forecasts associated with related entities with more accuracy by using a metric forecast entity relationship machine learning model.

To make solutions of the disclosure more comprehensible for a person skilled in the art, the following implementations of the disclosure are described with reference to the accompanying drawings.

Terms such as “a first”, “a second”, “a third”, and “a fourth” (if any) in the summary, claims, and foregoing accompanying drawings of the disclosure are used to distinguish between similar objects and are not necessarily used to describe a specific sequence or order. It should be understood that the terms so used are interchangeable under appropriate circumstances, so that the implementations of the disclosure described herein are, for example, capable of being implemented in sequences other than the sequences illustrated or described herein. Furthermore, the terms “include” and “have” and any variations thereof, are intended to cover a non-exclusive inclusion. For example, a process, a method, a system, a product, or a device that includes a series of steps or units, is not necessarily limited to expressly listed steps or units but may include other steps or units that are not expressly listed or that are inherent to such process, method, product, or device.

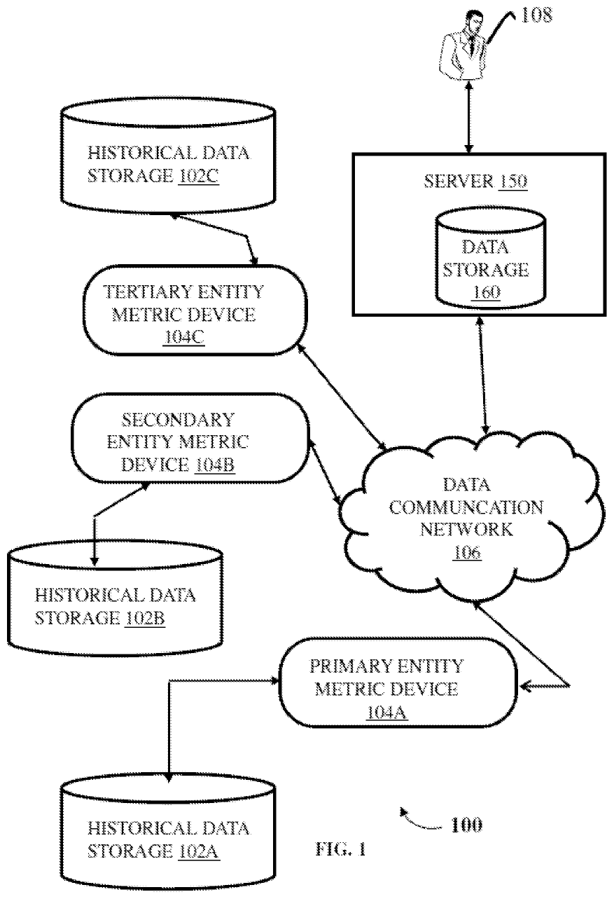

FIG. 1 is a block diagram that illustrates a computing environment 100 in which a server 150 is operable to estimate metric forecasts associated with related entities with more accuracy by using a metric forecast entity relationship machine learning model in accordance with an embodiment of the disclosure.

The computing environment 100 is shown comprising historical data storages 102A-C, a primary entity metric device 104A, a secondary entity metric device 104B, a tertiary entity metric device 104C, a data communication network 106 and a server 150 comprising a data storage 160. Each of the historical data storages 102A-C represents a storage for historical data associated with each corresponding entity, by accessing which the metric forecast for the entity is generated. The historical data storages 102A-C, in addition includes historical and future planned values of internal and external factor groups at different levels for each associated entity. The primary entity metric device 104A, the secondary entity metric device 104B and the tertiary entity metric device 104C respectively interacts with historical data storages 102A- C while generating respectively a first primary entity metric forecast, a first second entity metric forecast and a first third entity metric forecast for corresponding entity.

The server 150 is configured to estimate metric forecasts associated with a set of related entities with more accuracy by training and applying a metric forecast entity relationship machine learning model. The relation between the entities is assumed to be of the first entity being primary entity, a second entity being secondary entity, a third entity being tertiary entity.

The server 150 interfaces with the primary entity metric device 104A to obtain a first primary entity metric forecast, the secondary entity metric device 104B to obtain a first secondary entity metric forecast and the tertiary entity metric device 104C to obtain a first tertiary entity metric forecast at different instances of time. The server 150 is further configured to train a metric forecast entity relationship machine learning model based on a relationship between the first primary entity metric forecast and the first secondary entity metric forecast to obtain a trained metric entity relationship machine learning model that accounts for the relationship between the first primary entity metric forecast and the first secondary entity metric forecast. The server 150 is configured to estimate a second primary entity metric forecast and a second secondary entity metric forecast based on the trained metric entity relationship machine learning model.

The server 150 is of advantage in that the server 150 is operable to provide an improved processing speed while estimating related metric forecast by training a metric entity relationship machine learning model. The system estimating the metric entity relationship machine learning model (built using programming languages such as R) is enabled to benefit from the hardware architecture including an optimized memory utilization for processing and thereby higher processing speed. In addition, the system due to the use of the metric entity relationship machine learning model for estimating metric forecasts improves the accuracy in estimating the metric forecasts associated with a plurality of related entities, at least, for reasons similar to that illustrated above with respect to the algorithms to process historical data values.

In an embodiment, the server 150 is configured to obtain historical and future planned values of internal and external factor groups at different levels. In an embodiment, the server 150 is configured to receive values associated with specific applicable ones of forecast rules or constraints and to calculate the first primary entity forecast and the first secondary entity forecast based on the received values of the forecast rules or constraints applicable.

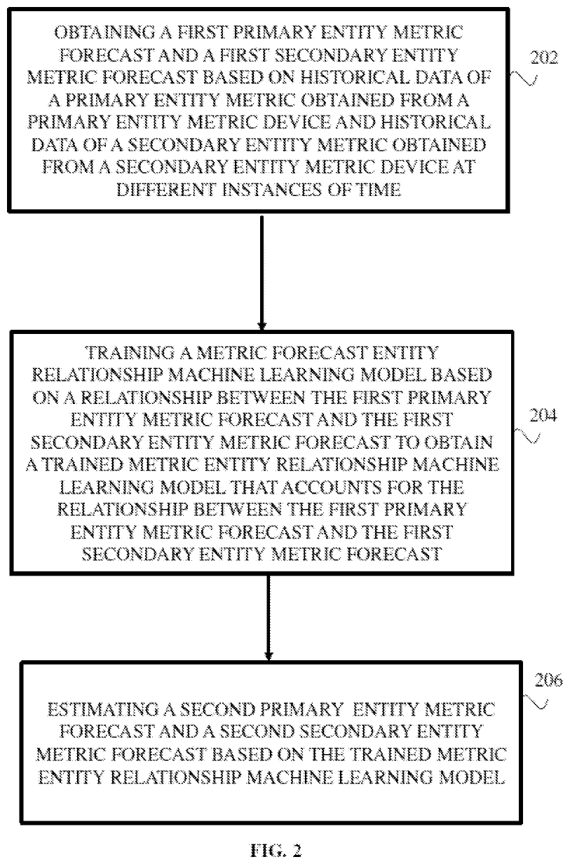

FIG. 2 is a flow diagram that illustrates steps of a method performed by server system for estimating metric forecasts associated with related entities with more accuracy by using a metric forecast entity relationship machine learning model in accordance with an implementation of the disclosure. At a step 202, the server 150 obtains a first primary entity metric forecast and a first secondary entity metric forecast based on historical data of a primary entity metric obtained from a primary entity metric device and historical data of a secondary entity metric obtained from a secondary entity metric device at different instances of time. The server 150 may interface with the primary entity metric device 104A, the secondary entity metric device 104B and the tertiary entity metric device 104C to obtain related entity metric forecasts.

At a step 204, a metric forecast entity relationship machine learning model is trained based on a relationship between the first primary entity metric forecast and the first secondary entity metric forecast to obtain a trained metric entity relationship machine learning model that accounts for the relationship between the first primary entity metric forecast and the first secondary entity metric forecast to obtain a trained metric entity relationship machine learning model that accounts for a relationship between the first primary entity metric forecast and the first secondary entity metric forecast. In an embodiment, the trained metric entity relationship machine learning model may be trained using methods including, but not limited to, advanced algorithms including but not limited to SVR, XGBoost, Random Forests, Prophet, DeepAR, LSTM/RNNs, Generative Adversarial Networks, Convolutional Neural Networks, Quantile Regressions, Bayesian Regressions, Factorization Machines, Bayesian Structural Time Series Models, Hidden Markov Models and Monte Carlo Markov Chains.

In an embodiment, the machine learning model trained accounts for the relationship between the first primary entity metric forecast (P) and the first secondary entity metric forecast (S) as a mathematical function such as the one below:

P=f(S)

In an embodiment, the machine learning model trained accounts for the relationship between a first primary entity metric forecast (P), a first secondary entity metric forecast (S) and a first tertiary entity metric forecast (T) as a mathematical function such as the one below:

P=f(S, T)

At a step 206, a second primary entity metric forecast and a second secondary entity metric forecast are estimated based on the trained metric entity relationship machine learning model.

Optionally, the method comprises applying at least one independent forecast rule or constraint on the first primary entity metric forecast and the first secondary entity metric forecast to obtain a first primary entity metric forecast and a first secondary entity metric forecast.

Optionally, the obtaining the first primary entity metric forecast and the first secondary entity metric forecast further comprises obtaining historical and future planned values of internal and external factor groups at different levels.

Optionally, the applying comprises receiving values associated with the at least one independent forecast rule or constraint of the corresponding first primary entity and first secondary entity of the plurality of related entities and calculating the first primary entity metric forecast and the first secondary entity metric forecast based on the values of the at least one independent forecast rule or constraint in obtaining the first primary entity metric forecast and the first secondary entity metric forecast.

According to another aspect of the disclosure, the trained metric entity relationship machine learning model indicates dependency between the first primary entity metric forecast and the first secondary entity metric forecast.

Optionally, the estimating of the second primary entity metric forecast and the second secondary entity metric forecast comprises performing the steps of: receiving values associated with the at least one independent forecast rule or constraint of the corresponding first primary entity and first secondary entity of the plurality of related entities; and calculating the first primary entity metric forecast and the first secondary entity metric forecast based on the values of the at least one independent forecast rule or constraint in obtaining the first primary entity metric forecast and the first secondary entity metric forecast and the calculating is based on the dependency existing between the variable elements of the first primary entity forecast and the first secondary entity forecast.

In an embodiment, the plurality of related entities includes a first tertiary entity metric forecast based on historical data of a tertiary entity metric obtained from a tertiary entity metric device. Optionally, the obtaining includes a first primary entity metric forecast, a first secondary entity metric forecast and a first tertiary entity metric forecast based on historical data of a primary entity metric obtained from a primary entity metric device (104A), historical data of a secondary entity metric obtained from a secondary entity metric device (104B) and historical data of a tertiary entity metric obtained from a tertiary entity metric device (104C) at different instances of time.

In an embodiment, the training a metric forecast entity relationship machine learning model is based on a relationship between the first primary entity metric forecast, the first secondary entity metric forecast and the first tertiary entity metric forecast to obtain a trained metric entity relationship machine learning model that accounts for the relationship between the first primary entity metric forecast, the first secondary entity metric forecast and the first tertiary entity metric forecast. Optionally, the estimating includes estimating the second primary entity metric forecast, the second secondary entity metric forecast and the third secondary entity metric forecast is based on the trained metric entity relationship machine learning model.

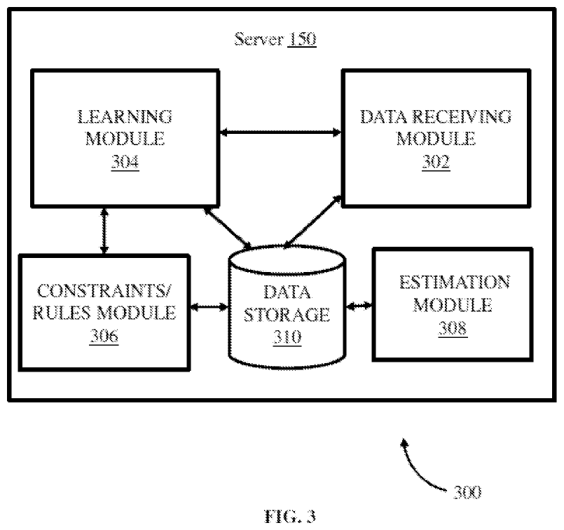

FIG. 3 is a block diagram that illustrates elements of the server (150) in accordance with an implementation of the disclosure. The block diagram 300 is shown comprising a data receiving module 302, a learning module 304, a constraints/ rules module 306, estimation module 308 and a data storage 310.

The data receiving module 302 interfaces with forecasting server 104 to receive in the data communication network 106, data comprising values associated with variables of related entity metric forecast. For example, data indicating a first primary entity metric forecast and a first secondary entity metric forecast based on historical data of a forecast variable at different instances of time may be obtained by the data receiving module 302.

In addition, the data receiving module 302 enables the server 150 to receive data values associated with corresponding one of the applicable forecast rules or constraints. Alternatively, the server 150 may receive such data values using the constrains/rules module 306, for example by enabling a user to perform a suitable corresponding action such as “data import” from a user interface in a display device connected with the server 150 or the like. The constrains/rules module 306 interacts with the data storage 310 while performing actions such as storing and/or retrieving data values associated with the forecast rules or constraints and with the learning module 304 as described in detail below.

The learning module 304 enables the server 150 to execute corresponding instructions to perform corresponding actions related to obtaining a trained metric entity relationship machine learning model. For example, the learning module 304 interacts with the data receiving module 302 to access historical values of associated variable elements included in the first primary entity metric forecast and historical values of associated variable elements included in the first secondary entity metric forecast at the different instances of time. The learning module 304 further may interact with any or both of the constraints/rules module 306, the data storage 310 to access values associated with any applicable constraints/rules. The learning module 304 based on the received data values noted above trains a metric forecast entity relationship machine learning model to obtain a trained metric entity relationship machine learning model that accounts for a relationship between the first primary entity metric forecast and the first secondary entity metric forecast.

The estimation module 308 enables the server 150 to perform corresponding actions in estimating a second primary entity metric forecast and a second secondary entity metric forecast based on the trained metric entity relationship machine learning model on the first primary entity metric forecast and the first secondary entity metric forecast. In an embodiment, the estimation module 308 enables the server 150 to perform corresponding actions in calculating the measurable values of each variable element included in the first primary entity forecast and the first secondary entity forecast based on the received values associated with each of the specific applicable forecast rules or constraints.

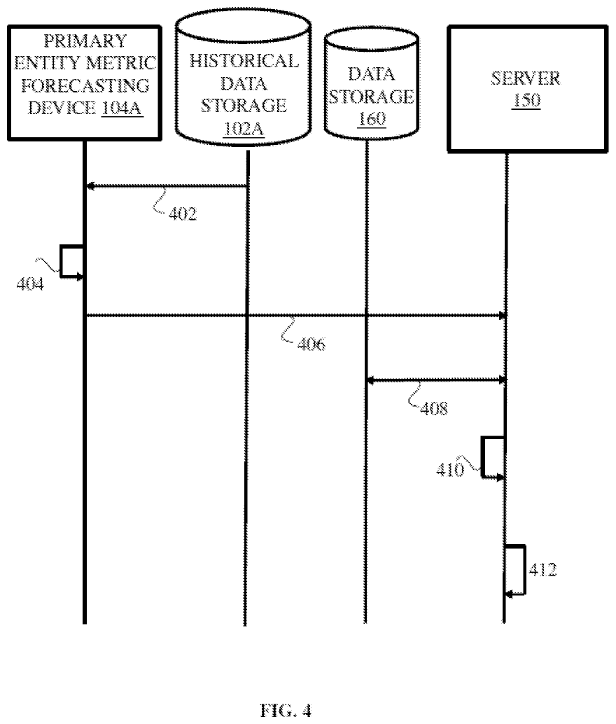

FIG. 4 is an interaction diagram that illustrates a method of estimating metric forecasts associated with related entities with more accuracy by using a metric forecast entity relationship machine learning model in accordance with an example implementation of the disclosure. At a step 402, historical data of a primary entity metric and a secondary entity metric at different instances of time that is stored in the historical data storage 150 is received at the primary entity metric forecast device 104A. At a step 404, the forecasting system 104 determines data values with associated variables for corresponding forecast metrics of related entities. At a step 406, a first set of metric forecasts of related entities are obtained at the server 150. At a step 408, the server 150 interacts with the data storage 160 to store/access values associated with any applicable constraints/rules. At a step 410, the server 150 performs training a metric forecast entity relationship machine learning model based on a relationship between the first primary entity metric forecast and the first secondary entity metric forecast to obtain a trained metric entity relationship machine learning model that accounts for the relationship between the first primary entity metric forecast and the first secondary entity metric forecast. At a step 412, the sever 150 performs estimating a second primary entity metric forecast and a second secondary entity metric forecast based on the trained metric entity relationship machine learning model.

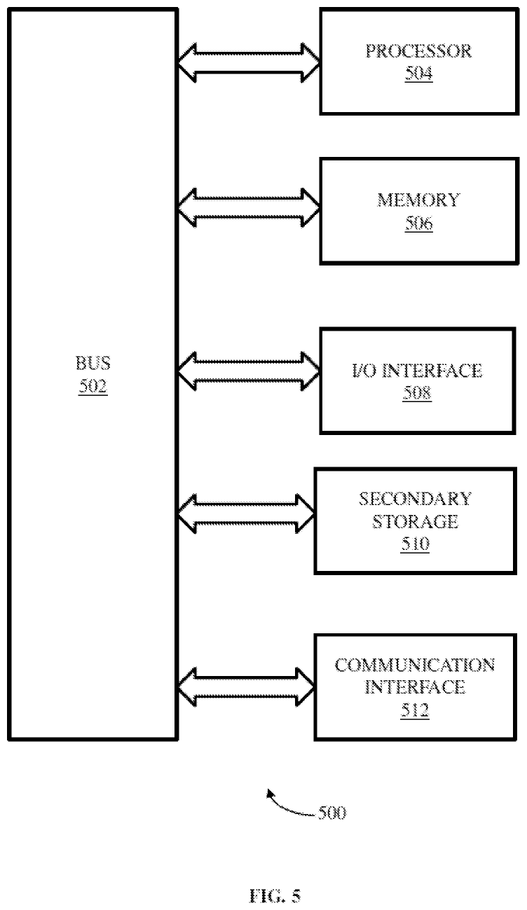

FIG. 5 is an illustration of an exemplary computer system 500 in which the various architectures and functionalities of the various previous implementations may be implemented. As shown, the computer system 500 includes at least one processor 504 that is connected to a bus 502, wherein the computer system 500 may be implemented using any suitable protocol, such as PCI (Peripheral Component Interconnect), PCI-Express, AGP (Accelerated Graphics Port), HyperTransport, or any other bus or point-to-point communication protocol (s). The computer system 500 also includes a memory 506.

Control logic (software) and data are stored in the memory 506 which may take a form of random-access memory (RAM). In the disclosure, a single semiconductor platform may refer to a sole unitary semiconductor-based integrated circuit or chip. It should be noted that the term single semiconductor platform may also refer to multi-chip modules with increased connectivity which simulate on-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The computer system 500 may also include a secondary storage 510. The secondary storage 510 includes, for example, a hard disk drive and a removable storage drive, representing a floppy disk drive, a magnetic tape drive, a compact disk drive, digital versatile disk (DVD) drive, recording device, universal serial bus (USB) flash memory. The removable storage drive at least one of reads from and writes to a removable storage unit in a well-known manner.

Computer programs, or computer control logic algorithms, may be stored in at least one of the memory 506 and the secondary storage 510. Such computer programs, when executed, enable the computer system 500 to perform various functions as described in the foregoing. The memory 506, the secondary storage 510, and any other storage are possible examples of computer-readable media.

In an implementation, the architectures and functionalities depicted in the various previous figures may be implemented in the context of the processor 504, a graphics processor coupled to a communication interface 512, an integrated circuit (not shown) that is capable of at least a portion of the capabilities of both the processor 504 and a graphics processor, a chipset (namely, a group of integrated circuits designed to work and sold as a unit for performing related functions, and so forth).

Furthermore, the architectures and functionalities depicted in the various previous-described figures may be implemented in a context of a general computer system, a circuit board system, a game console system dedicated for entertainment purposes, an application-specific system. For example, the computer system 500 may take the form of a desktop computer, a laptop computer, a server, a workstation, a game console, an embedded system.

Furthermore, the computer system 500 may take the form of various other devices including, but not limited to a personal digital assistant (PDA) device, a mobile phone device, a smart phone, a television, and so forth. Additionally, although not shown, the computer system 500 may be coupled to a network (for example, a telecommunications network, a local area network (LAN), a wireless network, a wide area network (WAN) such as the Internet, a peer-to-peer network, a cable network, or the like) for communication purposes through an I/0 interface 508.

It should be understood that the arrangement of components illustrated in the figures described are exemplary and that other arrangement may be possible. It should also be understood that the various system components (and means) defined by the claims, described below, and illustrated in the various block diagrams represent components in some systems configured according to the subject matter disclosed herein. For example, one or more of these system components (and means) may be realized, in whole or in part, by at least some of the components illustrated in the arrangements illustrated in the described figures.

In addition, while at least one of these components are implemented at least partially as an electronic hardware component, and therefore constitutes a machine, the other components may be implemented in software that when included in an execution environment constitutes a machine, hardware, or a combination of software and hardware.

Although the disclosure and its advantages have been described in detail, it should be understood that various changes, substitutions, and alterations can be made herein without departing from the spirit and scope of the disclosure as defined by the appended claims.

1. A method for estimating metric forecasts associated with a plurality of related entities with more accuracy by training and applying a metric forecast entity relationship machine learning model, wherein the method comprises:
obtaining (202) a first primary entity metric forecast and a first secondary entity metric forecast based on historical data of a primary entity metric obtained from a primary entity metric device (104A) and historical data of a secondary entity metric obtained from a secondary entity metric device (104B) at different instances of time;
training (204) a metric forecast entity relationship machine learning model based on a relationship between the first primary entity metric forecast and the first secondary entity metric forecast to obtain a trained metric entity relationship machine learning model that accounts for the relationship between the first primary entity metric forecast and the first secondary entity metric forecast; and
estimating (206) a second primary entity metric forecast and a second secondary entity metric forecast based on the trained metric entity relationship machine learning model.

2. The method of claim 1, wherein the method comprises applying at least one independent forecast rule or constraint on the first primary entity metric forecast and the first secondary entity metric forecast to obtain a first primary entity metric forecast and a first secondary entity metric forecast.

3. The method of claim 1, wherein the obtaining the first primary entity metric forecast and the first secondary entity metric forecast further comprises obtaining historical and future planned values of internal and external factor groups at different levels.

4. The method of claim 2, wherein the applying comprises:
receiving values associated with the at least one independent forecast rule or constraint of the corresponding first primary entity and first secondary entity of the plurality of related entities; and
calculating the first primary entity metric forecast and the first secondary entity metric forecast based on the values of the at least one independent forecast rule or constraint in obtaining the first primary entity metric forecast and the first secondary entity metric forecast.

5. The method of claim 1, wherein the trained metric entity relationship machine learning model indicates the specific ones of the forecast rules or constraints to use from the at least one independent forecast rule or constraint in performing the estimating, the dependency between the first primary entity metric forecast and the first secondary entity metric forecast.

6. The method of claim 1, wherein the estimating further comprises performing the steps of:
receiving values associated with specific applicable ones of forecast rules or constraints; and
calculating the first primary entity forecast and the first secondary entity forecast based on the receiving.

7. The method of claim 4, wherein the calculating is based on the dependency existing between the first primary entity forecast and the first secondary entity forecast.

8. The method of claim 1, wherein the plurality of related entities comprises a first tertiary entity metric forecast based on historical data of a tertiary entity metric obtained from a tertiary entity metric device wherein:
the obtaining comprises a first primary entity metric forecast, a first secondary entity metric forecast and a first tertiary entity metric forecast based on historical data of a primary entity metric obtained from a primary entity metric device (104A), historical data of a secondary entity metric obtained from a secondary entity metric device (104B) and historical data of a tertiary entity metric obtained from a tertiary entity metric device (104C) at different instances of time;
the training a metric forecast entity relationship machine learning model is based on a relationship between the first primary entity metric forecast, the first secondary entity metric forecast and the first tertiary entity metric forecast to obtain a trained metric entity relationship machine learning model that accounts for the relationship between the first primary entity metric forecast, the first secondary entity metric forecast and the first tertiary entity metric forecast; and
the estimating the second primary entity metric forecast, the second secondary entity metric forecast and the third secondary entity metric forecast is based on the trained metric entity relationship machine learning model.

9. A system (100) for estimating metric forecasts associated with a plurality of related entities with more accuracy by training and applying a metric forecast entity relationship machine learning model, wherein the system (100) comprises:
one or more historical data storages (102A-C);
a data communication network (106);
a primary entity metric device (104A);
a secondary entity metric device (104B);
a tertiary entity metric device (104C);
a server (150); and
a data storage (160) wherein the server (150) is operable to perform the steps of:
obtaining (202) a first primary entity metric forecast and a first secondary entity metric forecast based on historical data of a primary entity metric obtained from a primary entity metric device (104A) and historical data of a secondary entity metric obtained from a secondary entity metric device (104B) at different instances of time;
training (204) a metric forecast entity relationship machine learning model based on a relationship between the first primary entity metric forecast and the first secondary entity metric forecast to obtain a trained metric entity relationship machine learning model that accounts for the relationship between the first primary entity metric forecast and the first secondary entity metric forecast; and
estimating (206) a second primary entity metric forecast and a second secondary entity metric forecast based on the trained metric entity relationship machine learning model.

10. The system of claim 9, wherein the server (150) further performs the step of applying at least one independent forecast rule or constraint on the first primary entity metric forecast and the first secondary entity metric forecast to obtain a first primary entity metric forecast and a first secondary entity metric forecast.

11. The system of claim 9, wherein the obtaining the first primary entity metric forecast and the first secondary entity metric forecast further comprises obtaining historical and future planned values of internal and external factor groups at different levels.

12. The system of claim 10, wherein the applying comprises:
receiving values associated with the at least one independent forecast rule or constraint of the corresponding first primary entity and first secondary entity of the plurality of related entities; and
calculating the first primary entity metric forecast and the first secondary entity metric forecast based on the values of the at least one independent forecast rule or constraint in obtaining the first primary entity metric forecast and the first secondary entity metric forecast.

13. The system of claim 9, wherein the trained metric entity relationship machine learning model indicates the specific ones of the forecast rules or constraints to use from the at least one independent forecast rule or constraint in performing the estimating, the dependency between the first primary entity metric forecast and the first secondary entity metric forecast.

14. The system of claim 9, wherein the estimating further comprises performing the steps of:
receiving values associated with specific applicable ones of forecast rules or constraints; and
calculating the first primary entity forecast and the first secondary entity forecast based on the receiving.

15. The system of claim 14, wherein the calculating is based on the dependency existing between the first primary entity forecast and the first secondary entity forecast.
